(19) United States
(12) Patent Application Publication
(10) Pub. No.: US 2004/0267577 A1
(43) Pub. Date: Dec. 30, 2004

(54) Method and apparatus for managing risk of disaster

(76) Inventor: Kentaro Nakai, Chiyoda-ku (JP)

Correspondence Address: BIRCH STEWART KOLASCH & BIRCH, PO BOX 747, FALLS CHURCH, VA, 22040-0747, US

(21) Appl. No.: 10/745,666

(22) Filed: Dec. 29, 2003

(30) Foreign Application Priority Data
Jun. 30, 2003 (JP) JP2003-187252

(51) Int. Cl. G06F 17/60

(52) U.S. Cl. 705/4

(57) ABSTRACT

An administrator server receives evaluation results having identifying information regarding the risk of a disaster with respect to each of a plurality of components of a building from a plurality of specialized consultant's. The administrator then prepares an evaluation list regarding the entire building by integrating a plurality of evaluation results having the same identifying information. Therefore, a fair and accurate rating of the entire building can be obtained by integrating evaluation results regarding the risk of a disaster with respect to the building from a plurality of specialized consultants.

### CROSS-REFERENCE TO RELATED APPLICATIONS

This nonprovisional application claims priority under 35 U.S.C. § 119(a) on Patent Application No. 2003-187252, filed in Japan on Jun. 30, 2003, the entirety of which is incorporated herein by reference.

### BACKGROUND OF THE INVENTION

1. Field of the Invention

The present invention relates to a method and apparatus for managing a risk of disaster. In particular, the present invention relates to a method and apparatus for administrating a risk of an earthquake disaster.

2. Description of Background Art

The diagnosis of earthquake resistance (seismic performance) and the performance of reinforcement work for earthquake resistance with respect to a building are known. In addition, housing quality is professionally guaranteed or is basically assured legally and a third party typically conducts the quality inspection. Furthermore, earthquake insurance is in common usage and insurance payments from earthquake insurance are typically used as the funds for restoration of the building after a disaster.

Currently, international transactions for real estate have been increasing. In view of this, due diligence regarding the value of an investment target in the trade is required. In addition, it is very important that the value of the real estate as security be appropriately estimated through detailed investigation and diagnosis. According to one aspect of due diligence, fair and accurate evaluation is desired with respect to the diagnosis and rating of the earthquake resistance of a building, which have a great effect on the estimation of real estate value.

A building is; however, constituted by many different components, such as the building frame (the skeleton and the like), the finish (interior finish work and exterior finish work), the equipment (air conditioners, heating systems, etc.) the building fixtures and the building furniture (chairs, desks, etc.). A building often includes a steel-structure building frame as the main frame of the building.

It is difficult and/or may not have high reliability for a single specialist company (specialized consultant) to make a diagnosis of the earthquake resistance and the rating of the building, which includes so many different components. For example, the diagnosis of the earthquake resistance or a proposal regarding how to perform necessary reinforcement work to improve the earthquake resistance of a steel-structure building frame cannot be highly reliable without the help/participation by a specialist company who is highly capable of designing and constructing a steel-structure building frame.

However, there has not been a system for making a diagnosis of the earthquake resistance and the rating of a building by integrating the knowledge of a plurality of specialist companies. In view of this, it has been difficult to make an accurate rating with respect to the earthquake resistance of a building.

Technology has been proposed for selecting a proper restoring agency by diagnosing a defect of a building. However there is no indication of diagnosing a building defect by integrating the knowledge of a plurality of specialist companies in a particular technology.

Without the diagnosis of the earthquake resistance and the rating of the building by integrating the knowledge of a plurality of specialist companies, it is difficult to realize a comprehensive and consistent service which covers the diagnosis of earthquake resistance of a building, the rating of the earthquake resistance of a building, the performance of the necessary reinforcement work for improving the earthquake resistance of a building, earthquake insurance and restoration assurance after a disaster. If the diagnosis of the earthquake resistance and the rating of the building are available, a comprehensive service can be consistently presented based on a common index of the fair earthquake resistance evaluation and the rating. It is impossible to determine a reference or a standard for providing a comprehensive and consistent service, if there is no available evaluation and rating of the earthquake resistance evaluation of a building.

Thus, a building owner has not been able to take advantage of such a comprehensive service covering from the diagnosis of the earthquake resistance of a building to the restoration of the building after a disaster has occurred. In view of this, it is necessary for the owner to contact, negotiate and contract with many different companies and/or agencies that deal with all of the necessary functions of a building. Particularly, it has been almost impossible to make the use of a service which assures the restoration of a building after a disaster, i.e., to contract for an assurance of the restoration of a building after a disaster, which is made in advance based on a proper diagnosis of the earthquake resistance and the rating of a building, so that quick action for the restoration of the building can be obtained.

The situation mentioned above is found not only in administrating the risk of an earthquake, but also in administrating the risk of other disasters.

### SUMMARY OF THE INVENTION

An object of the present invention is to provide a method and apparatus for managing the risk of a disaster, which enables an evaluation of an entire building fairly and accurately for determining the rating of the building. The rating of the building is carried out by integrating the evaluation results of the risk of a disaster obtained from a plurality of specialists and to present a comprehensive and consistent service which covers an evaluation of the risk of a disaster, a rating of the building, disaster insurance and restoration assurance of a building after a disaster.

The object of the invention is accomplished by a method for managing the risk of a disaster on a building utilizing an administrator server, said method comprising steps of:

issuing identifying information to identify the building;

classifying components of the building into a plurality of segments;

sending a request for evaluation with the identifying information regarding the risk of a disaster with respect to each of the components of the building to a plurality of specialized consultants corresponding to each of the plurality of segments;

receiving evaluation results with the identifying information regarding the risk of a disaster with respect to each of the components from each of the plurality of specialized consultants; and

preparing an evaluation regarding the risk of a disaster on the entire building by integrating the plurality of evaluation results having the same identifying information.

The object of the invention is also accomplished by a computer-readable article of manufacture having embodied thereon software comprising a plurality of code segments that implement the above method of the present invention in order to manage the risk of a disaster on a building.

The object of the invention is further accomplished by an apparatus for managing the risk of a disaster on a building utilizing an administrator server, said apparatus comprising:

means for issuing identifying information to identify the building;

means for classifying components of the building into a plurality of segments;

means for sending a request for evaluation with the identifying information regarding the risk of a disaster with respect to each of the components of the building to a plurality of specialized consultants corresponding to each of the plurality of segments;

means for receiving evaluation results with the identifying information regarding the risk of a disaster with respect to each of the components from each of the plurality of specialized consultants; and

means for preparing an evaluation regarding the risk of a disaster on the entire building by integrating the plurality of evaluation results having the same identifying information.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates an example of a network system where a method for managing the risk of a disaster according to a first embodiment of the present invention is applied;

FIG. 2 is a block diagram of the administrator server 100 shown in FIG. 1;

FIG. 3 illustrates an example of a data base, which is configured in the storage part 104 shown in FIG. 2;

FIG. 4 illustrates an example of user data available in the network system in FIG. 1;

FIG. 5 illustrates an example of building data available in the network system in FIG. 1;

FIG. 6 illustrates an example of a specialized consultant and builder list available in the system in FIG. 1;

FIG. 7 is a flowchart showing a process flow according to the first embodiment of the method for managing risk according to the present invention;

FIG. 8 is a flowchart subsequent to FIG. 7;

FIG. 9 is a flowchart subsequent to FIG. 8;

FIG. 10 is a flowchart subsequent to FIG. 9;

FIG. 11 is a flowchart subsequent to FIG. 10;

FIG. 12 is a flowchart subsequent to FIG. 11;

FIG. 13 is a flowchart subsequent to FIG. 12;

FIG. 14 is an example of a top page image displayed on a Comprehensive Earthquake Risk Assurance website;

FIG. 15 is an example of a building data registration form image displayed on the Comprehensive Earthquake Risk Assurance website;

FIG. 16 is an example of an evaluation result image displayed on the Comprehensive Earthquake Risk Assurance website;

FIG. 17 is an example of an image of the result of a specified component to be reinforced, which is displayed on the Comprehensive Earthquake Risk Assurance website;

FIG. 18 is an example of an image of the draft proposal of the restoration assurance of a building after a disaster, which is displayed on the Comprehensive Earthquake Risk Assurance website;

FIG. 19 is an example of an image of an earthquake insurance setting form, which is displayed on the Comprehensive Earthquake Risk Assurance website;

FIG. 20 is an example of an image of a calculated insurance fee, which is displayed on the Comprehensive Earthquake Risk Assurance website;

FIG. 21 illustrates an example of a cover letter printed out by a building owner's terminal shown in FIG. 1;

FIG. 22 illustrates an example of a request for evaluation form with respect to a building frame;

FIG. 23 illustrates an example of a request for evaluation form with respect to the finish of a building;

FIG. 24 illustrates an example of an evaluation list of the entire building;

FIG. 25 illustrates an example of a weighting list;

FIG. 26 illustrates an example of a weighted evaluation list;

FIG. 27 illustrates an example of a total evaluation point-rating list indicating a relationship between an evaluation point and a rating;

FIG. 28 illustrates an example of an Annualized Loss Exceedance Curve list; and

FIG. 29 illustrates an example of an Annualized Loss Exceedance Curve.

### DETAILED DESCRIPTION OF THE PREFERRED EMBODIMENTS

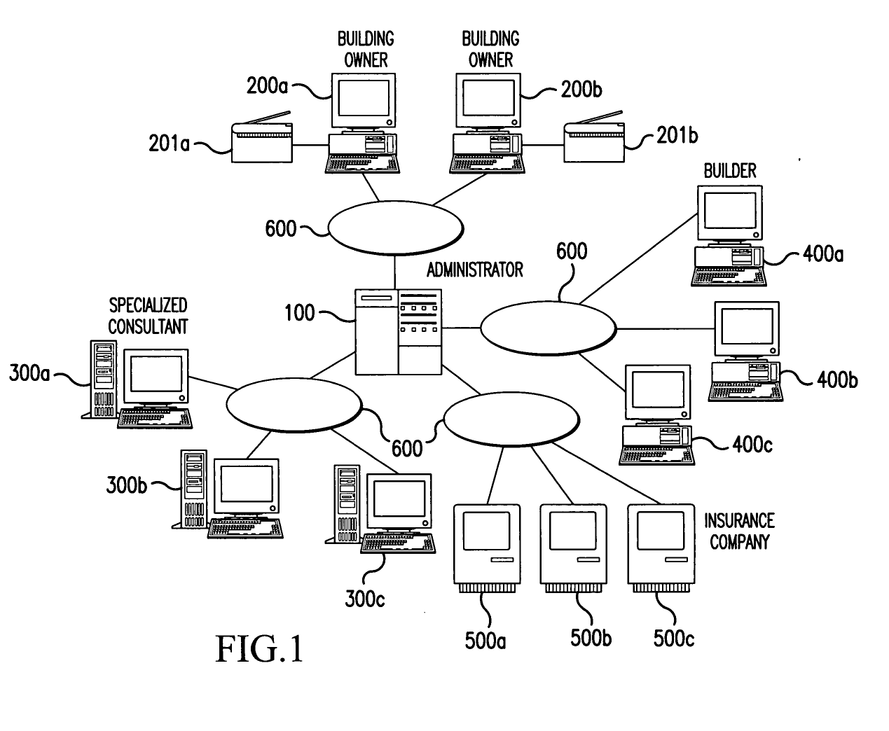

The present invention will now be described with reference to the accompanying drawings. FIG. 1 illustrates an example of a network system where a method for managing risk of disaster according to a first embodiment of the present invention is applied. The first embodiment of the present invention is directed to a network system for managing the risk of earthquake disaster; however, it should be understood that the present invention is not limited to earthquake disaster. For example, the method and apparatus of the present invention would operate equally as well for managing the risk of other disasters such as hurricanes, fires, etc.

Referring to FIG. 1, a network system includes an administrator server 100, a building owner's terminals 200a, 200b, a specialized consultant's terminals 300a-300c, a builder's (construction company's or contractor's) terminals 400a-400b and an insurance company's terminals 500a-500c. The administrator server and the other terminals are connected to communicate via network 600.

It should be noted that the present invention is not limited to the different kinds of terminals illustrated in FIG. 1. Depending on a particular application, other terminal types can also be used. In addition, it should be noted that the number of each type of terminal is not limited to the number shown in FIG. 1. More or less of each type of terminal may be included in the network system of the present invention.

The administrator server 100 is for presenting a Comprehensive Earthquake Risk Assurance (CERA) analysis. The administrator server 100 includes a server and one or more personal computer workstations to access the server.

The administrator server 100 administrates a website for conducting the CERA analysis. In the website, an evaluation of earthquake resistance, a rating of earthquake resistance is conducted. In addition, necessary reinforcement work, earthquake insurance and restoration assurance after a disaster are presented to the building owner's terminal 200a, 200b. The administrator server 100 should be run by a highly public and neutral organization as it carries out a rating of the earthquake resistance of a building.

The building owner's terminals 200a, 200b are the building owner's or a related party's computer terminals. The building owner's terminals are for receiving the services supplied by the administrator server 100. The building owner's terminals 200a, 200b can include copying machines 201a, 201b, which are available as scanners and/or printers. In the building owner's terminals 200a, 200b, a browser software (web page browsing software) and e-mail software for sending/receiving e-mails are installed.

The specialized consultant's terminals 300a-300c are the computers of specialized consultants knowledgeable about various components of a building. As will be described later, the components of a building are classified according to different segments of a building such as the building frame (the skeleton of the building and the like), the building finish (interior finish work and exterior finish work), the building equipment (air conditioners, heating systems, etc.), the building fixtures, the building furniture (chairs, desks, etc.) and the building grounds. The specialized consultant's terminals 300a-300c are provided for each of the different classifications of components. For example, a steel structure division of a steel manufacturer, who is an expert in steel structural engineering, is a relevant specialized consultant for a steel structure frame of a steel-frame building. Also a division of a construction consulting company is a relevant specialized consultant for a building frame (including steel piling and foundation structures) of a reinforced concrete building other than a steel-frame building. Other specialized consultants for earthquake resistance can be provided for the building finish, equipment, fixtures, furniture and grounds. The number of different segments and therefore the number of the specialized consultant's terminals 300a-300c can be modified depending on the application; however, it is preferred that there are at least two different segments into which building components are classified and therefore two specialized consultant's terminals.

Each specialized consultant makes a field examination to conduct an analysis of the earthquake resistance of a building. Consequently, a mobile note-type personal computer, an electronic organizer (PDA) or the like can be used as the specialized consultant's terminals 300a-300c or can be attached to the specialized consultant's terminals 300a-300c.

Terminals 400a-400b are computers for a builder (construction company) who contracts for necessary reinforcement work for each component of a building.

Terminals 500a-500b are computers for an insurance company who handles earthquake insurance for paying money to the building owner when damage occurs from an earthquake disaster.

The above-mentioned browser and e-mail software should preferably be installed in the specialized consultant's terminals 300a-300c, the builder's (construction company's) terminals 400a-400b and the insurance company's terminals 500a-500c, so that each of the various parties can communicate with the administrator server 100 through the network 600. The network 600 through which the administrator server 100 and each of the terminals are connected can be a LAN, a WAN where LANs are connected or the Internet.

In the first embodiment of the present invention, the various components of a building are classified into predetermined segments based on data of a target building and an evaluation of the earthquake resistance of the building, which is ordered from each of the specialized consultants.

Then evaluation results of the earthquake resistance of each component which are input by each specialized consultant are gathered and integrated by the administrator to prepare an evaluation list that describes the entire evaluation of the earthquake resistance of the target building. The prepared evaluation list is presented to the building owner. A rating of the building is then made based on the evaluation list, which is accurately prepared by integrating the evaluation results of the earthquake resistance of the building through the specialized consultants. If the building owner desires to obtain a higher rating, the necessary reinforcement work required to obtain the higher rating is presented to the owner based on the evaluation list. The builder (construction company) then carries out the reinforcement work.

Assurance of restoration after disaster, which is a contract made in advance for assuring restoration after disaster so that the quick action for restoration can be taken after disaster, can also be set up by administrator server 100 based on the evaluation list. An insurance fee for earthquake insurance, which pays insurance money when earthquake disaster damage occurs, can be estimated based on the evaluation list to broker the earthquake insurance contract between the building owner and the insurance company.

As described above, the evaluation of the earthquake resistance of a building, the rating of the earthquake resistance of a building, the reinforcement work of the building, earthquake insurance and restoration assurance of the building after a disaster are comprehensively presented by the administrator server 100 which presents the Comprehensive Earthquake Risk Assurance (CERA) analysis.

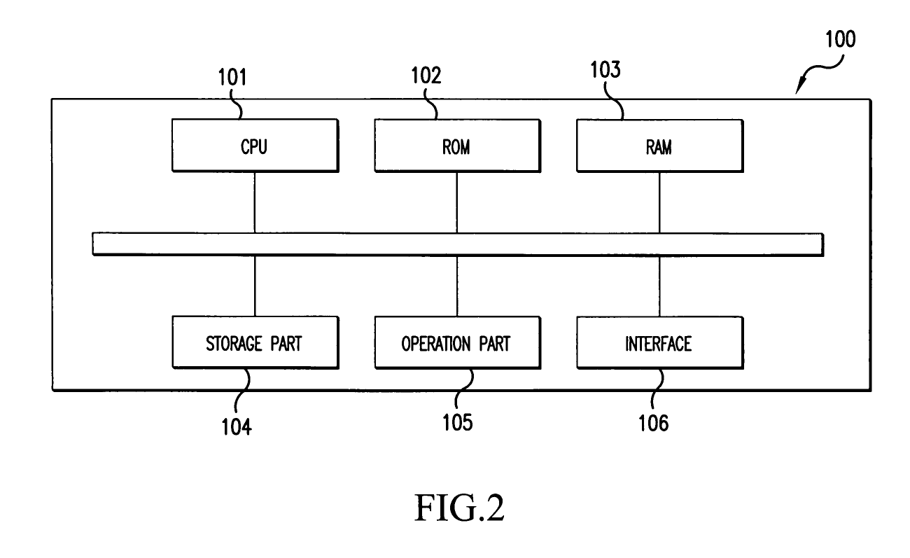

FIG. 2 is a block diagram of an administrator server 100. The administrator server 100 includes a CPU 101, a ROM 102, a RAM 103, a storage part 104, an operation part 105 and an interface 106. The CPU 101 is a processor for a variety of computing and controlling operations. The CPU 101 performs a variety of processing operations for the CERA analysis by running a computer program. The ROM 102 is a memory for storing a variety of control programs and parameters necessary for performing processing operations for the CERA analysis. The RAM 103 is for temporarily storing data and is also a working area for a variety of computing operations by the CPU 101. The operation part 105 is a keyboard and/or a pointing device such as a mouse, which is used for inputting parameters or providing processing instructions. The interface 106 is for connecting the administrator server 100 to each of the terminals 200a, 200b, 300a-300c, 400a-400b and 500a-500b, so that communication can be performed between them.

The storage part is a storage device such as a hard disk drive or a magnetic optical disk device for storing a variety of data files and program modules carried out by the CPU 101. By carrying out program modules stored in the storage part 104, the CPU can fulfill a user administration function, a building data administration function, a specialized consultant and builder administration function, an evaluation list preparation function, an earthquake resistance rating function, a restoration assurance setting function and an insurance fee calculation function.

The user administration function is a function for administrating the data of a building owner (user). A user ID for identifying the user is issued by this function. The building data administration function is a function for administrating building data of the target building. A building ID for identifying the target building is issued by this function. The building ID is used to identify the target building when an evaluation of the earthquake resistance of a building is forwarded to the specialized consultant and an evaluation result of the earthquake resistance of the building is received from the specialized consultant.

The specialized consultant and builder administration function is a function for administrating data of the specialized consultant and the builder. The evaluation list preparation function is a function for preparing an evaluation list with respect to the entire building by integrating the evaluation results of each of the components received from the plurality of specialized consultants. The earthquake resistance rating function is a function for rating the earthquake resistance of the target building based on the evaluation list. The restoration assurance setting function is a function for setting up the aforementioned restoration assurance for the building after the disaster has occurred, based on the evaluation list. The insurance fee calculation function is a function for calculating an insurance fee for the earthquake insurance based on the evaluation list.

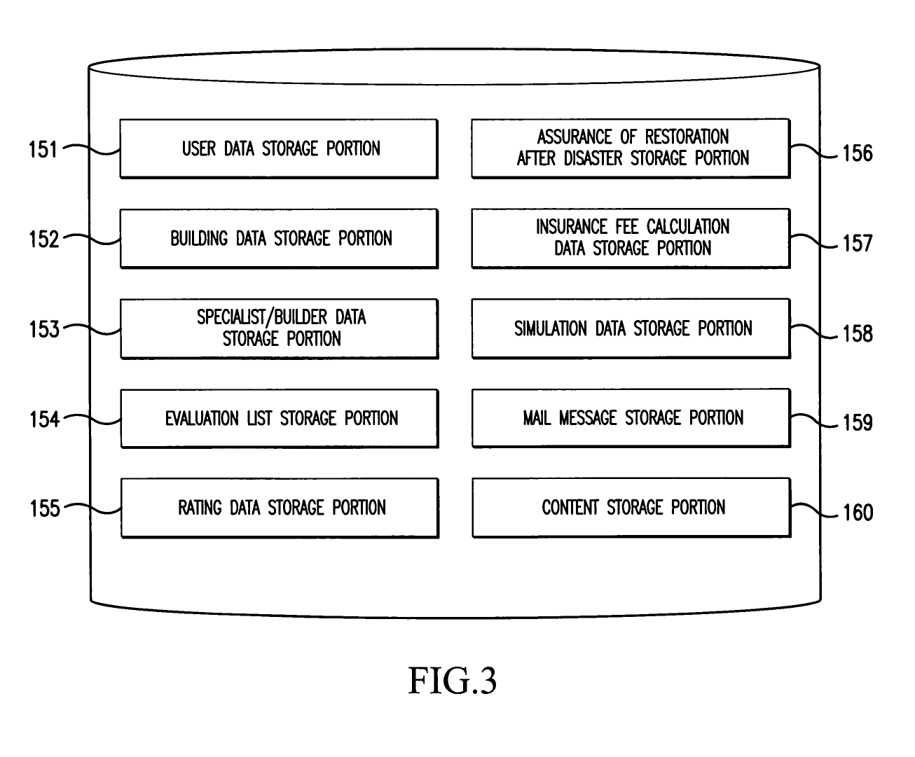

As shown in FIG. 3, a variety of databases are configured in a logical disk of a storage part 104, which functions as storage portions for various data.

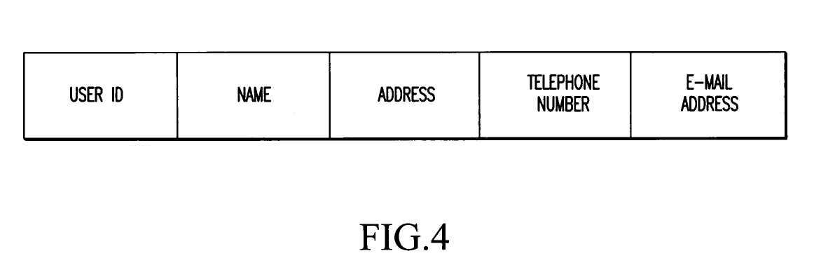

A user data storage portion 151 stores user data about the user, e.g., the building owner. As shown in FIG. 4, the user data includes the user's name, address, telephone number, e-mail address and the like. The user data is input at the building owner's terminal and is received by the administrator server 100 via the network 600. Some parts of the user data can be forwarded to the administrator by using ways other than communication through the network 600. The user data is accompanied by the user ID, which has been issued by the administrator server 100 when the user is first registered on the CERA website.

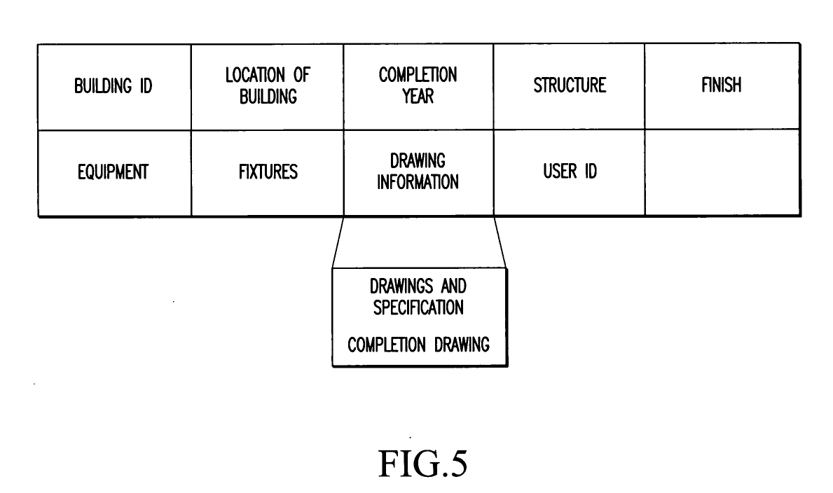

A building data storage portion 152 stores building data regarding the target building. As shown in FIG. 5, the building data includes the location, completion year, the details of the building frame structure, the details of the finish, the details of the equipment, the details of the fixtures and furniture, the drawing information and the user ID. The drawing information includes image data of the drawings and specification, and a completion drawing. Alternatively, the drawing information may include a link to a separately stored image data file of the drawing and specification, and the completion drawing.

The building data is input by the building owner and/or the administrator. For example, different kinds of simple data, i.e., data only required for simple simulation described later, can be input by the building owner, while detailed data should be input by an administrator having a high engineering capability based on the drawings and specification and the completion drawing. The reason for this is that the amount of the data is usually huge and the administrator is more equipped to handle this data. When a portion of the building data is input by the building owner, the administrator server 100 receives the data through the network 600. Some portions of the building data can be sent to the administrator using ways other than by communicating through the network 600. The building data is accompanied by the building ID (identifying information) for identifying the target building, which is issued by the administrator server 100 when the building is registered on the CERA website.

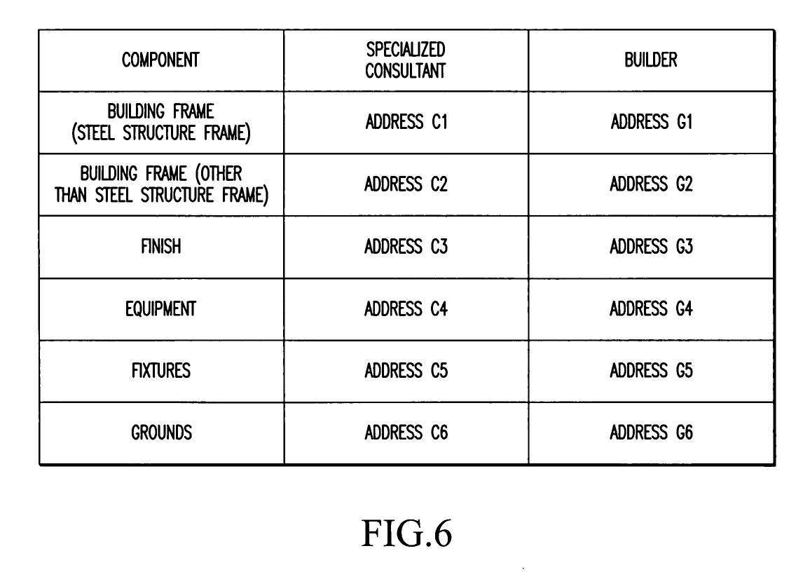

As shown in FIG. 6, a specialized consultant and builder data storage portion 153 stores information of a specialized consultant and a builder, which are set up for each of the different components of a building classified according to the predetermined segments. The information is, for example, the e-mail address and the IP address of the specialized consultant and the builder.

An evaluation list storage portion 154 stores an evaluation list of the entire building, which has been prepared by integrating the evaluation results of each component sent by a plurality of specialized consultants' terminals 300a-300c. The details of the evaluation list will be described below.

A rating data storage portion 155, an assurance of restoration after the disaster storage portion 156 and an insurance fee calculation data storage portion 157 store data for rating the building, data for setting an assurance of restoration after the disaster and data for calculating an insurance fee of the earthquake insurance, respectively. The details of the data will be described below.

A simulation data storage portion 158 stores data for performing a simple simulation on the CERA website of to inform the user of each service of the CERA analysis. The simulation data storage portion 158 can be omitted when the simulation service is not presented.

A mail message storage portion 159 stores messages such as e-mail text to be sent from an administrator server 100 to each of the terminals 200a, 200b, 300a-300c, 400a-400c and 500a-500c. A content storage portion 160 stores contents such as text data, images and icons to form the CERA web page.

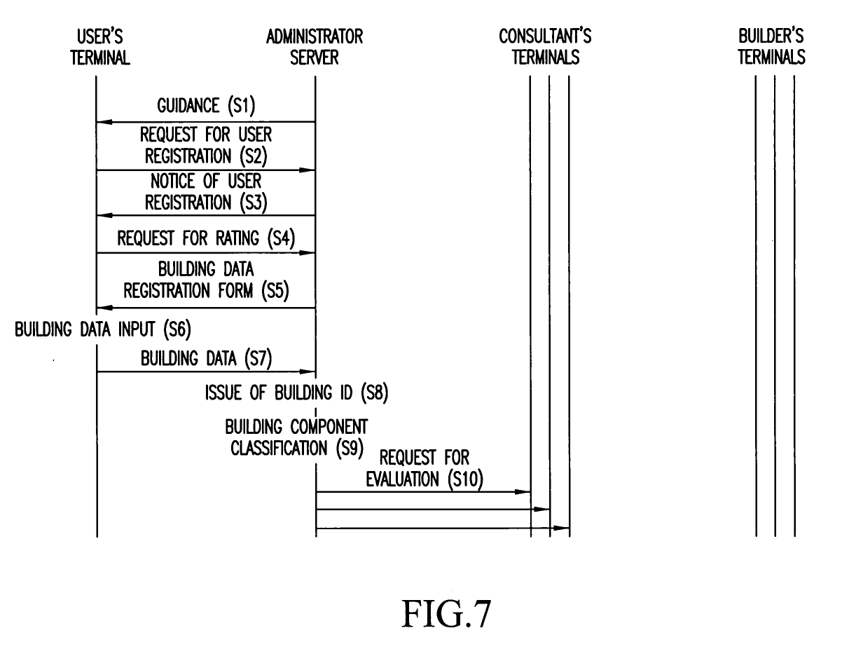

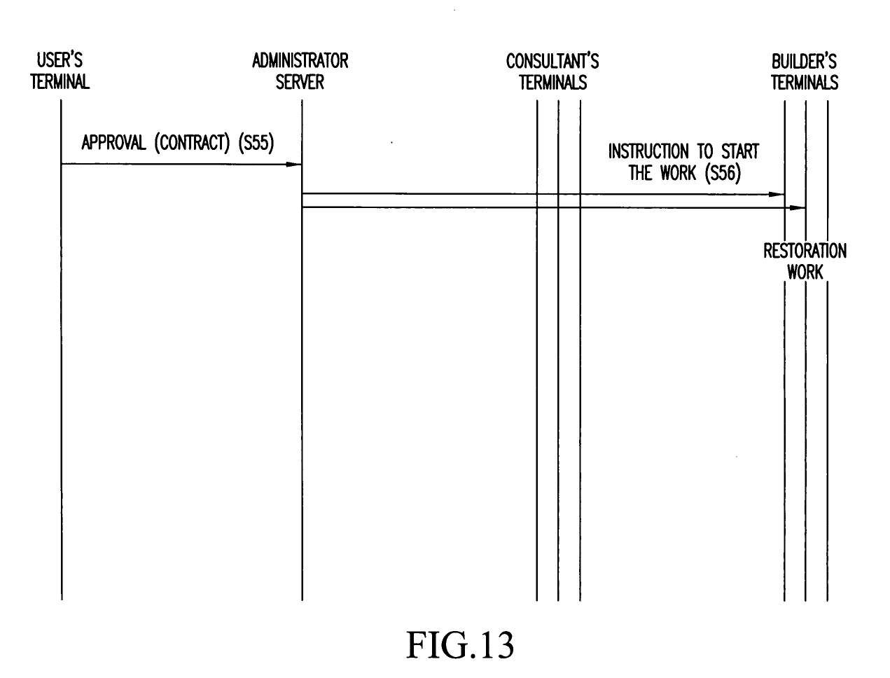

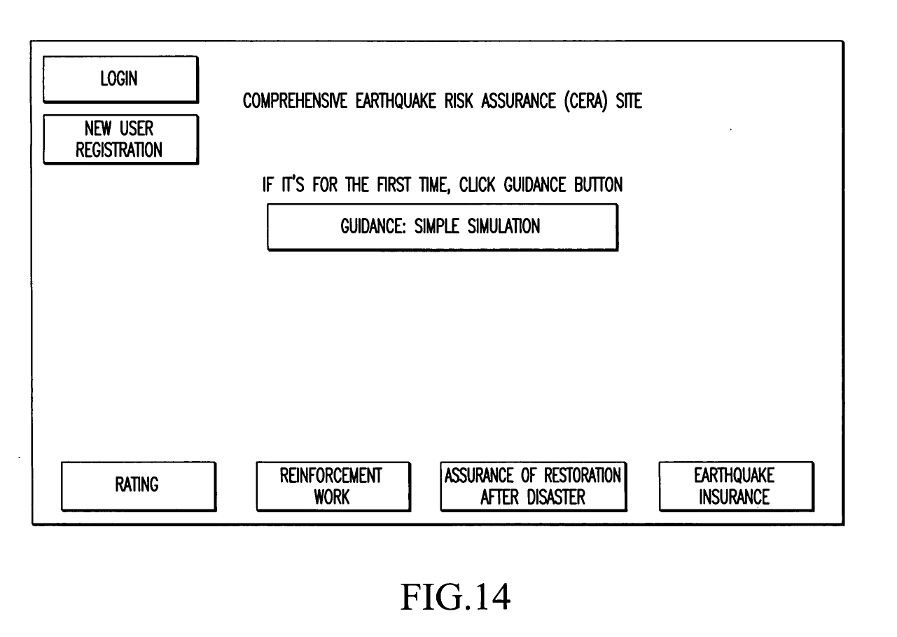

An embodiment of the method for managing risk using the above described network system will now be described. FIGS. 7-13 are flowcharts illustrating the process flow in this embodiment of the method for managing risk according to the present invention. FIGS. 14-20 are examples of images displayed on the building owner's terminals 200a and 200b.

At step S1 of FIG. 7, the administrator server 100 displays guidance for the Comprehensive Earthquake Risk Assurance on the building owner's terminal 200a, 200b when a user accesses the CERA website. For example, when a user, who visits the CERA website for the first time, clicks the button entitled “Guidance: Simple Simulation” on a top page of the site shown in FIG. 14, a simple simulation menu is displayed. The user can then learn the details of the assurance restoration, fee system etc. from the Simple Simulation menu.

In the Simple Simulation menu, the user can virtually experience an outline of each process of the rating, the instruction of the reinforcement work, the setting of the restoration assurance after a disaster, and the insurance fee calculation for the earthquake insurance, for example, with respect to an office building having a steel-structure frame (10 years old, 20 stories, total floor space 20,000 m²).

At step S2, when the user who is attracted by the guidance clicks a new user registration button on the top page shown in FIG. 14, a user data input page (not shown) is displayed where a variety of information such as the user's name, address, telephone number and e-mail address are entered. When the administrator server 100 receives the information, the server issues a user ID for each user. As a result, the user data with the user ID is stored in the user data storage portion 151 in the administrator server 100 as shown in FIG. 4.

At step S3, a notice of user registration completion is sent from the server 100 to the user by using e-mail. The e-mail of a notice of user registration completion includes the user ID and password. After completion of user registration, the user can make use of the CERA service by clicking the login button and entering the user ID and password. As shown in FIG. 14, the user can enjoy each of the services after login by clicking buttons on the top page for the services of rating, reinforcement work, assurance of restoration after disaster and earthquake insurance. The processing of each of the services is described below.

Processing of Rating

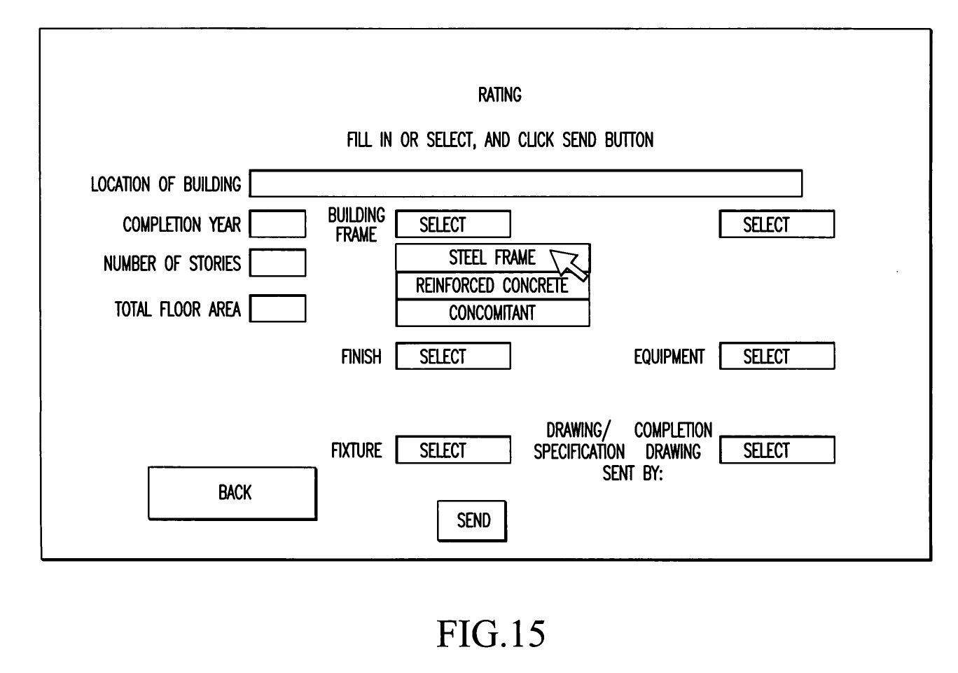

At step S4, the administrator server 100 receives the instruction of rating when the rating button is clicked. At step S5, the administrator server 100 then sends a building data registration form, shown in FIG. 15, to be displayed on a display device of the building owner's terminal 200a, 200b.

At step S6, building data such as the location of the building, completion year, the structure of the building frame skeleton, the structure of other building frames, the details of the finish, the details of the equipment and the details of the fixtures and furniture are input into the building data registration form by the user.

When the send button shown in FIG. 15 is clicked, the administrator server 100 receives the building data from the building owner's terminal 200a, 200b at step S7. The building data is data for the target building. The building data is received through the network 600. Some portions of the building data can be provided to the administrator using ways other than communication through the network 600. For example, in situations where the drawings and specification and completion drawing are not converted into image data, the drawings and specification and completion drawing can be sent by mail or delivered by hand. Any detailed data in the building data, which is used for processing of the final rating, can be input through the administrator server 100 based on the drawings and specification and completion drawing.

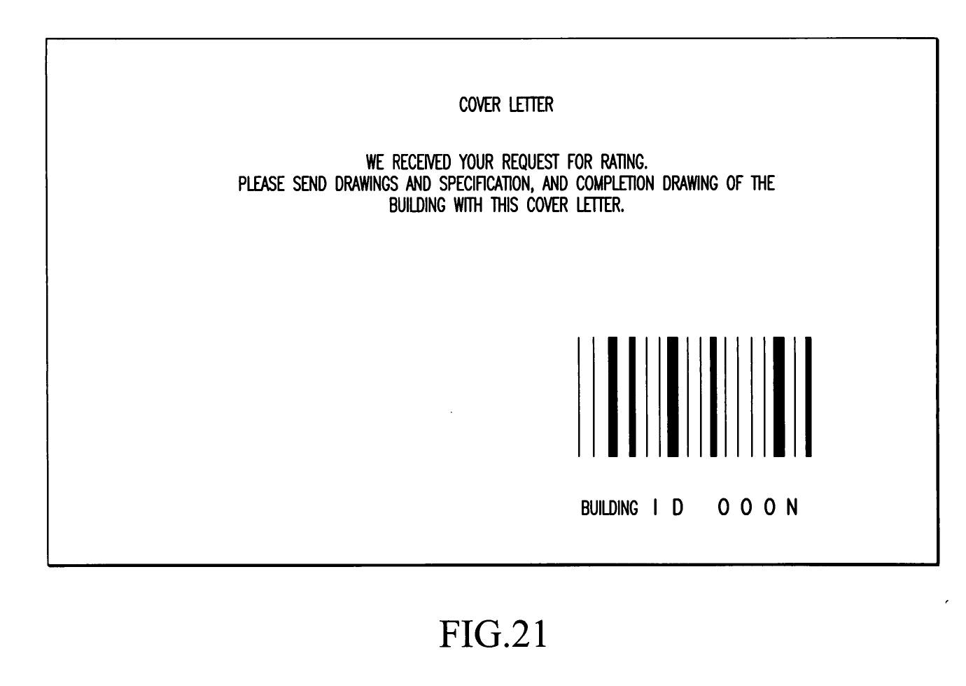

At step S8, the administrator server 100 issues a building ID to identify the target building. If the drawings and specification and completion drawing are received through ordinary mail or by hand, the administrator server 100 can then send printing data for printing a cover letter with the building ID to a building owner's terminal 200a, 200b in advance. The building owner's copy machine with printing function 201a, 201b prints out a cover letter with the building ID, which includes a bar code shown in FIG. 21 or other code based on the printing data sent from the administrator server 100. The building owner then mails or hands over the drawings and specification and completion drawing to which the printed cover letter is attached to the administrator. Preferably, the drawings and specification and completion drawing are converted into electronic image data by a scanner (not shown) and are stored as an image data file. In addition, the bar code on the attached cover letter is read at the same time by the scanner to recognize the building ID for the electronic image data from the drawings and specification and completion drawing. Thus, the information from the drawings and specification and completion drawing is added to building data.

At step S9, various components of the target building are classified according to the predetermined segments based on the building data. Components of building can be classified into five different segments. For example, the components of the building can be classified into “building frame,” “finish,” “equipment,” “fixture and furniture” and “grounds”. If the building frame includes a steel-structure building frame, the components can also be classified into “building frame (steel structure frame),” “building frame (other than steel structure frame),” “finish,” “equipment,” “fixture and furniture” and “grounds”. In addition, plural items of “finish,” “equipment,” and “fixture and furniture” can be integrated as one segment. In this case, the components of the building can be classified into “building frame,” “finish, equipment and fixture” and “ground”. Furthermore, “building frame” can be divided into “foundation structure,” “frame structure” and “floor structure,” “finish” can be divided into “interior finish work” and “exterior finish work,” and “equipment” can be, for example, divided into “electric equipment,” “air conditioning equipment” and “sanitary installation.” Consequently, the various components of the building in this case can be classified into “foundation structure,” “frame structure,” “floor structure,” “interior finish work,” “exterior finish work,” “electric equipment,” “air conditioning equipment,” “sanitary installation,” “fixture and furniture” and “grounds”.

Although the above segments have been described, it should be noted that the segments could be properly changed depending on the received details of the building data at step S7, i.e., the kind of target building.

As described above, the embodiment of the present invention can be applied as long as components of the building are classified into at least two segments. The following is an example where the components of a building are classified into five segments, i.e., building frame, finish, equipment, fixture and furniture, and grounds.

At step S10 in FIG. 7, a request for evaluation of the earthquake resistance with respect to each component is sent to terminals 300a-300c of a plurality of specialized consultants arranged for each of the segments the components of a building have been classified into.

For example, a specialized consultant and builder list, where addresses and who handles a particular component of building are listed, is read out from a specialized consultant and builder data storage portion 153. The request for evaluation of the earthquake resistance with respect to each component is then sent to the address of corresponding specialized consultant. The building ID is attached to the request.

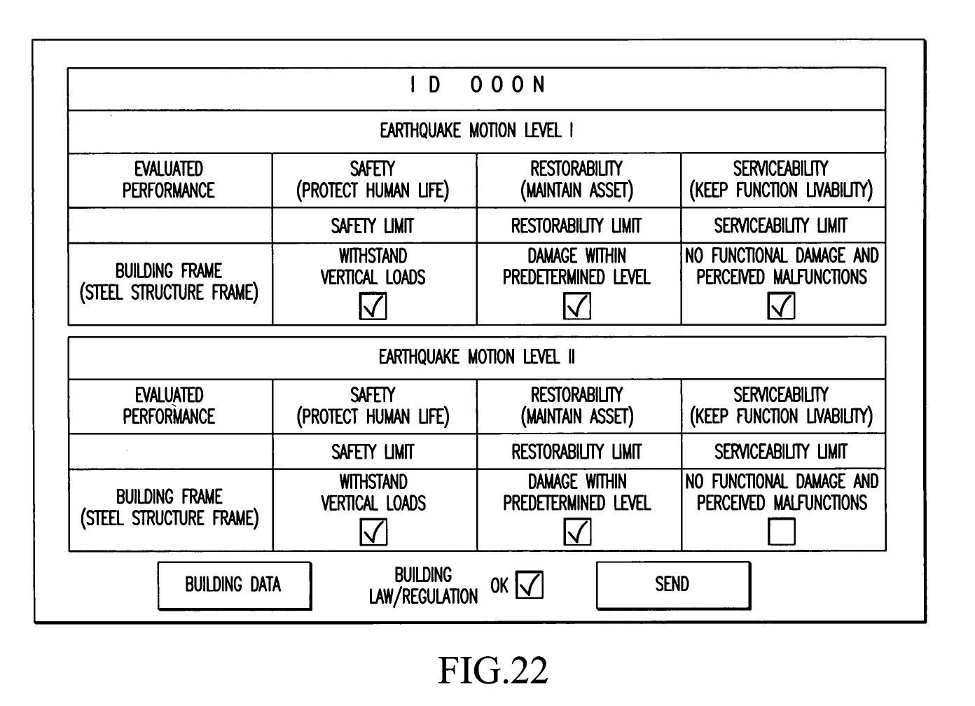

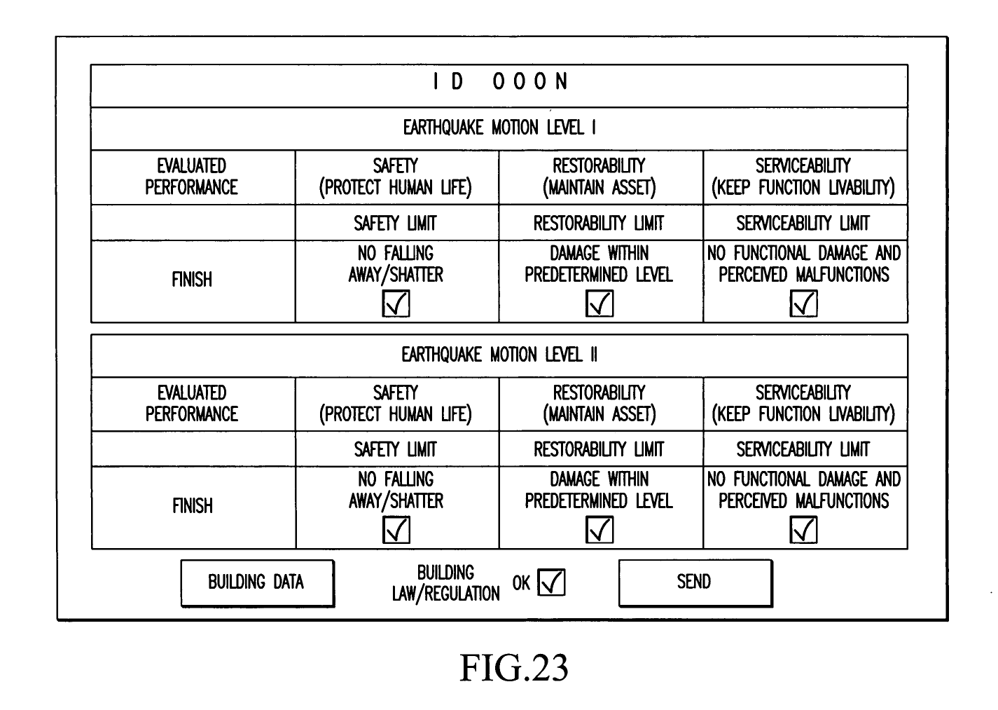

FIG. 22 illustrates an example of a request for evaluation form with respect to a building frame. FIG. 23 illustrates an example of a request for evaluation form with respect to the finish of a building. A request for evaluation with respect to the equipment, fixtures or grounds would be similar to FIGS. 22 and 23 and can be sent in the same way.

In the examples shown in FIG. 22 and FIG. 23, a request for evaluation is made with respect to a plurality of earthquake motion levels (ground motion levels), i.e., earthquake motion level I and earthquake motion level II, respectively. The earthquake motion level II is, for example, defined as an earthquake of the maximum level. Practically, the earthquake level II is, for example, assumed as an earthquake, which occurs once per 475 years based on past record, seismotectonics and active faults. The earthquake motion level I is, for example, defined as an earthquake level which occurs once every 10-50 years.

Three performance items, i.e., safety, restorability and serviceability are required for seismic performance (earthquake resistance performance) to be evaluated. With regard to the building frame, “withstand vertical loads” is required as a level of safety (safety limit) to protect human life, since the failure to withstand vertical loads will harm human life. As a level of restorability (restorability limit), “damage level is within a predetermined limit” is required, so that the restoration of the building frame can be feasibly made with reasonable efforts. With regard to a level of serviceability (serviceability limit), “free from functional damage and perceived malfunctions” is required, i.e., deformation/vibration of a building frame does not interfere with continued use. Likewise, with regard to the finish, equipment, fixtures and grounds, the same three performance items, i.e., safety, restorability and serviceability, are required for seismic performance to be evaluated.

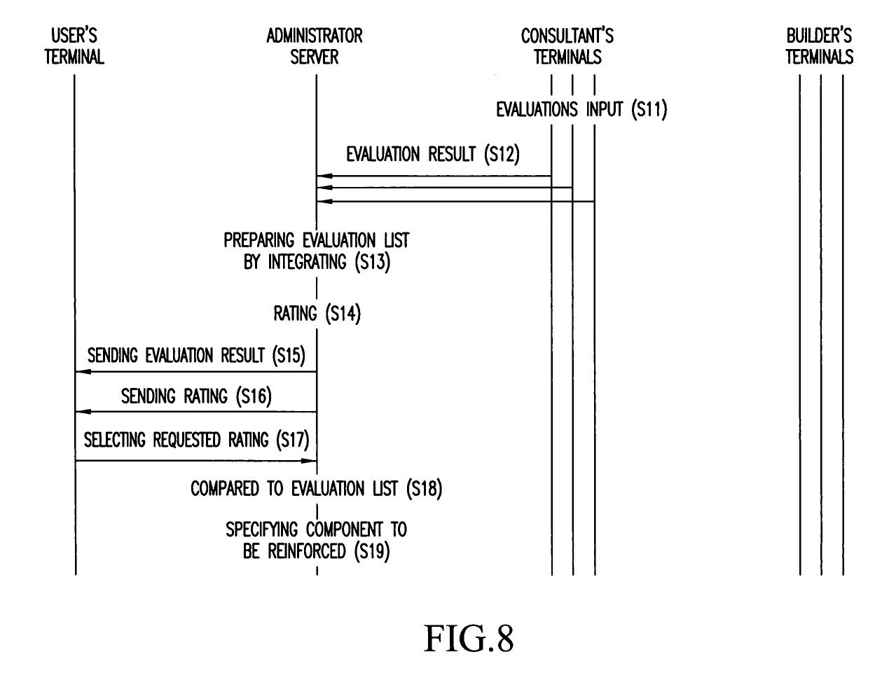

At step S11 in FIG. 8, each specialized consultant does a field examination, if necessary, and the evaluation results of the earthquake resistance of a target building component is entered through the specialized consultant's terminals 300a-300c. As shown in FIGS. 22 and 23, for example, the administrator server 100 displays a given form of a request for evaluation on the specialized consultant's terminals 300a-300c to ask for an input of the evaluation. Each specialized consultant enters the evaluation results regarding safety, restorability, serviceability in each of the earthquake motion levels I and II, and whether the current building law/regulation is met or not. The evaluation request form is displayed on the mobile terminal at this time. In this way, an evaluation result input form unified by the administrator can be presented to each of the specialized consultants' terminals 300a-300c.

Each of specialized consultants enters the evaluation results after making a structural analysis based on their own data. As shown in FIGS. 22 and 23, the system can allow each specialized consultant to access the building data by clicking a building data button. In this case, the administrator server 100 sends the building data to each of the specialized consultants' terminals 300a-300c upon receiving information that the building data button was clicked.

At step S12 in FIG. 8, the administrator server 100 receives the evaluation results of the earthquake resistance with the building ID with respect to each of the components such as the building frame, finish, equipment and fixtures from the specialized consultants' terminals 300a-300c when the send button shown in FIGS. 22 and 23 is clicked.

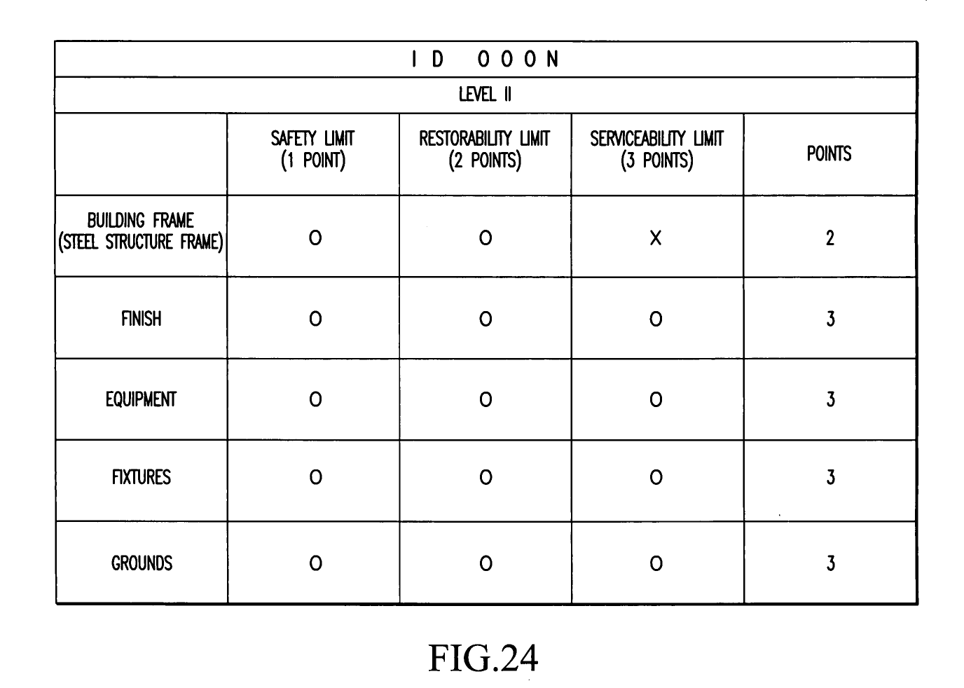

At step S13, the administrator server 100 integrates a plurality of evaluation results by retrieving the evaluation results of the earthquake resistance with respect to each of the components having the same building ID by using the building ID as a retrieving key. Thus the earthquake resistance evaluation list regarding the entire building is prepared. FIG. 24 illustrates an example of an evaluation list regarding an entire building. FIG. 24 illustrates an evaluation list for an earthquake of motion level II. An evaluation list for an earthquake of motion level I is also prepared in the same way. In this embodiment, three points are allocated when the level is met up to the serviceability limit, two points are allocated when the objective is met up to the restorability limit, and one point is allocated when only the objective of safety limit is met. The allocated points for each of the safety limit, restorability limit and serviceability limit is not always limited to the abovementioned allocated points, but is set at the administrator's discretion. In the example of FIG. 24, the allocated points for the building frame, finish, equipment, fixture and grounds are 2, 3, 3, 3 and 3 respectively.

As a basic evaluation, whether the target building can meet the current building law/regulation or not is evaluated. In this case, the building law/regulation items included in the evaluation result data sent from the specialized consultants' terminals 300a-300c could be referred to.

Then the PML (Probable Maximum Loss) is calculated as a primary evaluation. The PML is a percentage expression of a ratio of loss to asset value of the entire building. The loss is presumed to be caused by an earthquake of the maximum level, which is assumed as an earthquake occurring at a probability of once each 475 years. The evaluation result is obtained as a numeric value such as PML=15%. The calculation of the PML per se is well known except that a plurality of specialized consultants are now to be involved with the evaluation of earthquake resistance which is to be the basis for the PML calculation.

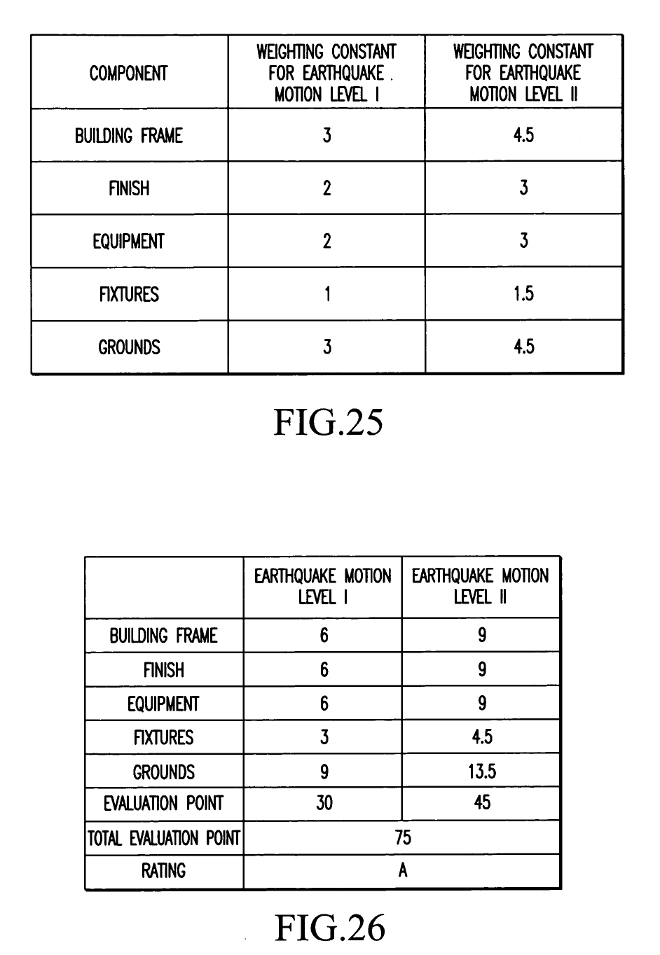

As a secondary evaluation, the rating of the earthquake resistance of the target building is made based on the evaluation list at step S14 in FIG. 8. First, a weighting list indicating a relationship between a weighting coefficient and the segment of components of the target building is read out from a rating data storage portion 155. An example of the weighting list is shown in FIG. 25. The weighting coefficient is set up in advance according to the level of importance of the segment. In this embodiment, the constants in the case of an earthquake of motion level I are 3 for the building frame and grounds, 2 for finish and equipment, and 1 for fixtures; and the constants for an earthquake of motion level II are 4.5 for the building frame and grounds, 3 for finish and equipment, and 1.5 for fixtures. It should be noted that the weighting coefficients are not limited to the ones mentioned above, and can be set up differently in advance in the weighting list. The allocated points calculated at step S13 are multiplied by the weighting coefficients. As a result, a weighted evaluation list shown in FIG. 26 is prepared. In the example of FIG. 26, weighted allocated points in the case of an earthquake of motion level I are 6, 6, 6, 3 and 9 for the building frame, finish, equipment, fixtures and grounds, respectively. An evaluation point defined as a summation of the weighted points is 30; and the weighted allocated points in the case of an earthquake of motion level II are 9, 9, 9, 4.5 and 13.5 for the building frame, finish, equipment, fixtures and grounds, respectively. An evaluation point is 45. A total evaluation point, defined as a summation of the evaluation points in the cases of earthquake motion levels I and II is 75. In this embodiment, the evaluation of earthquake motion level II is weighted more than that of level I by changing the weighting coefficients. An evaluation of earthquake motion level II can be weighted more than that of level I by increasing the allocated points for level II compared with the allocated points for the level I, while using common weighting coefficients.

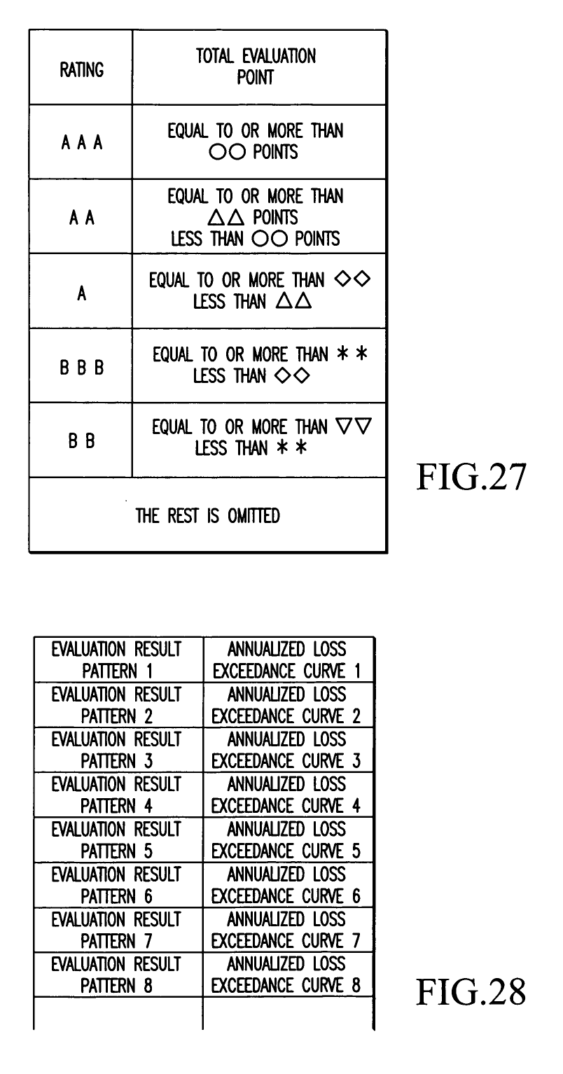

As shown in FIG. 27, a total evaluation point-rating list is read out and a rating is determined according to the result of the total evaluation points. In FIG. 26, the determined rating is “A”.

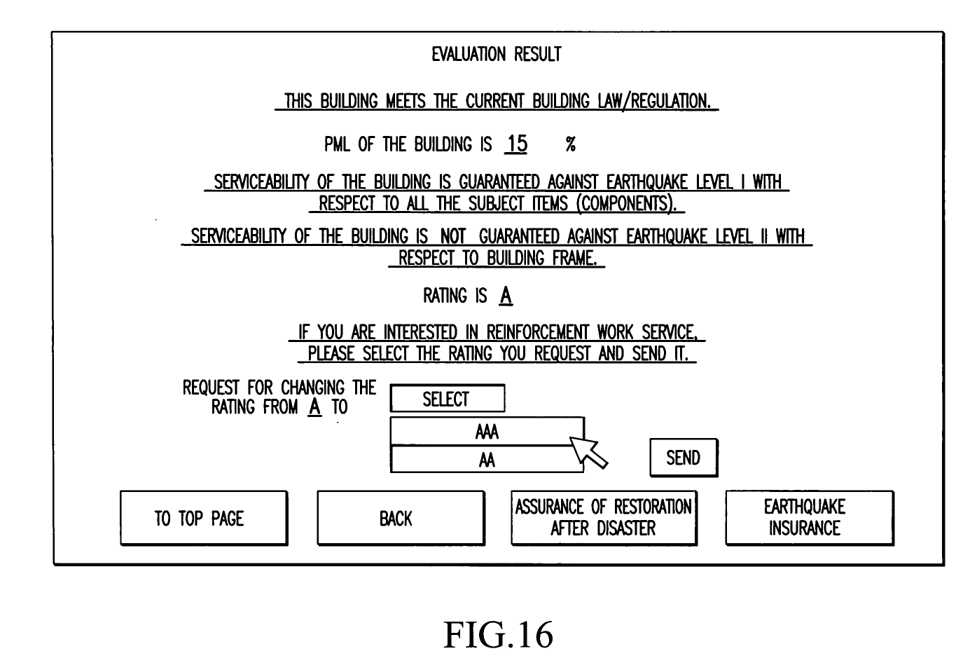

At steps S15 and S16, the administrator server 100 sends the evaluation result of the entire building and the rating to a building owner's terminal 200a, 200b. Namely, a content to be displayed (e.g., text) is read out from a content storage portion 160 according to the results of the basic evaluation, primary evaluation and secondary evaluation in steps S13 and S14 and is sent to the building owner's terminal 200a, 200b through the network 600. An image representing the evaluation results is displayed on the owner's terminal 200a, 200b as shown in FIG. 16. This is the end of processing of the rating.

Processing of Reinforcement Work

At step S17 in FIG. 8, the administrator server 100 receives a request for changing the rating to a requested rating. For example, the user can request for a change in the rating to a higher rating on the displayed form of the evaluation result shown in FIG. 16. In FIG. 16, the requested rating is selected and the send button is clicked. FIG. 16 illustrates an example where the user requests a change in the rating from “A” to “AAA.”

At step S18, the administrator server 100 seeks for a total evaluation point corresponding to the requested rating by referring to the abovementioned evaluation point-rating list. A model evaluation list to establish the requested rating is then prepared for comparison to a current evaluation list actually prepared at step S13.

At step S19, target items (components) to be reinforced by which the requested rating can be established are specified based on the result of comparison in step S18. For example, if it is found that improving an earthquake resistance performance of the building frame is effective to establish the requested rating, it is specified that the target component to be reinforced is a building frame.

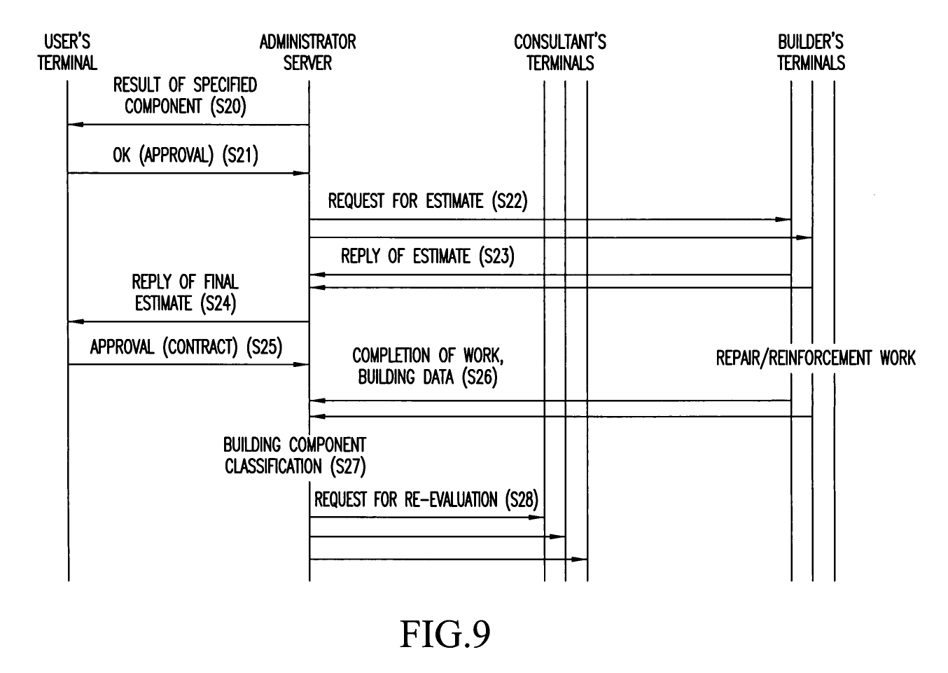

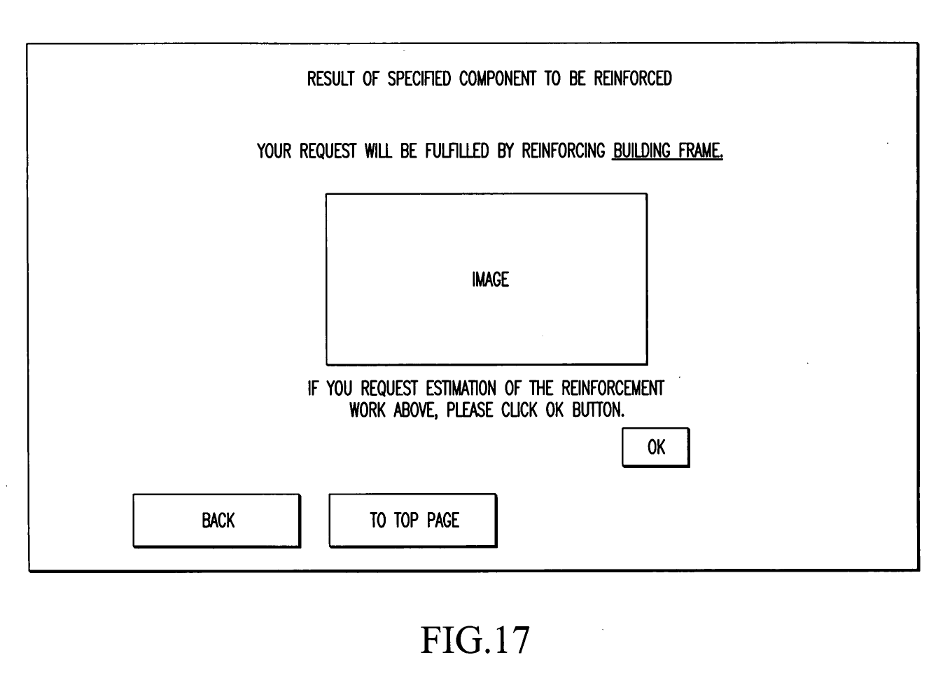

At step S20 in FIG. 9, the administrator server 100 sends the result of the specified component to be reinforced to the building owner's terminal 200a, 200b. The result is displayed as shown in FIG. 17.

If the OK button is clicked on the displayed image, the administrator server 100 receives an approval at step S21 and at step S22 sends the evaluation list, the model evaluation list, the building data and a request for an estimate to the terminal of the builder linked to the specified component.

More precisely, the aforementioned specialized consultant and builder list is read out from a specialized consultant and builder data storage portion 153. The request for an estimate is then sent to the address of the builder relevant to the component to be reinforced specified at step S19 based on the specialized consultant and builder list. The request for an estimate is made, e.g., by e-mail. The e-mail can be automatically edited by reading out a message stored in a mail message storage portion 159.

At step S23, the administrator server 100 receives a reply of an estimate from the builders' terminals 400a-400c. At step S24, an overhead for the administrator to supervise actual reinforcement work is added to the replied estimate. In other words, the administrator actually examines the work to supervise. The administrator server 100 sends a final estimate with the added overhead to the building owner's terminal 200a, 200b. The final estimate includes not only the necessary cost, but also a specification of the work. When the approval of the final estimate from the building owner's terminal 200a, 200b is received at step S25, the contract is concluded and the relevant builder starts actual reinforcement work (repair work).

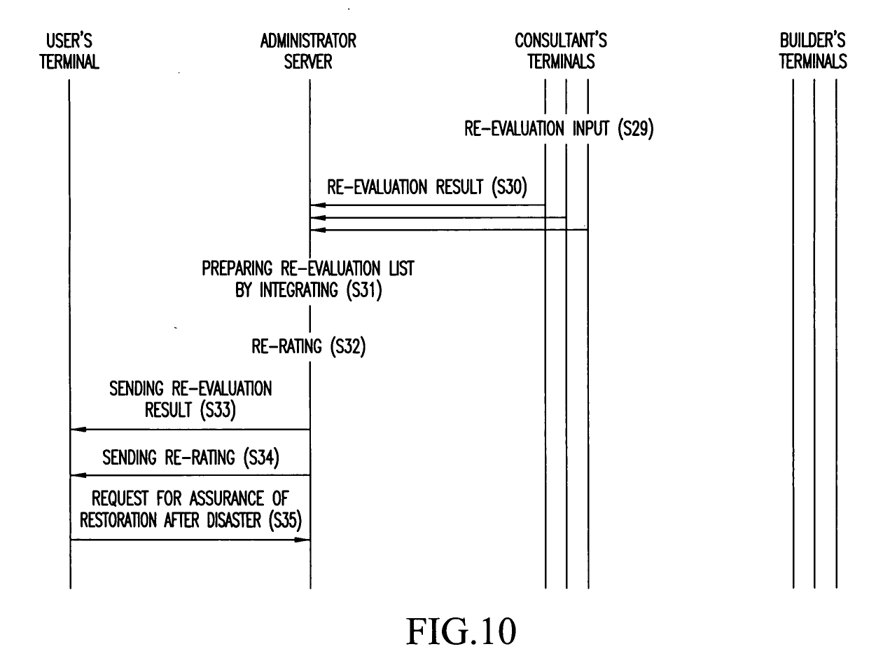

At step S26, the administrator server 100 receives the notice of completion of the work and the building data including the reinforcement and repair work. At the processing of steps S27-S34, the various components of the building are classified (at step S27) and a request for re-evaluation is sent to each of the specialized consultants' terminals 300a-300c (at step S28). At the specialized consultant's terminals 300a-300c, re-evaluation results are input (at step S29 in FIG. 10). The administrator server 100 receives a plurality of re-evaluation results from the specialized consultant's terminals 300a-300c (at step S30) and integrates a plurality of re-evaluation results to prepare a re-evaluation list(at step S31). Re-rating is then made based on the re-evaluation list (at step S32). The re-evaluation result and the re-rating are sent to the building owner's terminal 200a, 200b (at step S33 and S34) to display the re-evaluation result and the re-rating in the same way as the evaluation result page shown in FIG. 16. As a result, it is found that the PML is reduced and the rating is raised by the reinforcement work, which leads to a higher asset value of the real estate.

Assurance of Restoration After Disaster

At step S35 in FIG. 10, the administrator server 100 receives a request for assurance of restoration of the building after a disaster from the building owner's terminal 200a, 200b. For example, the user can make a request for an assurance of restoration of the building after a disaster by clicking an assurance-of-restoration-after-disaster button on the top page as shown in FIG. 14 or on an evaluation result displaying page as shown in FIG. 16. An assurance of restoration after disaster is a contract made in advance for assuring the restoration of a building after a disaster so that a quick action for restoration can be taken if a disaster occurs.

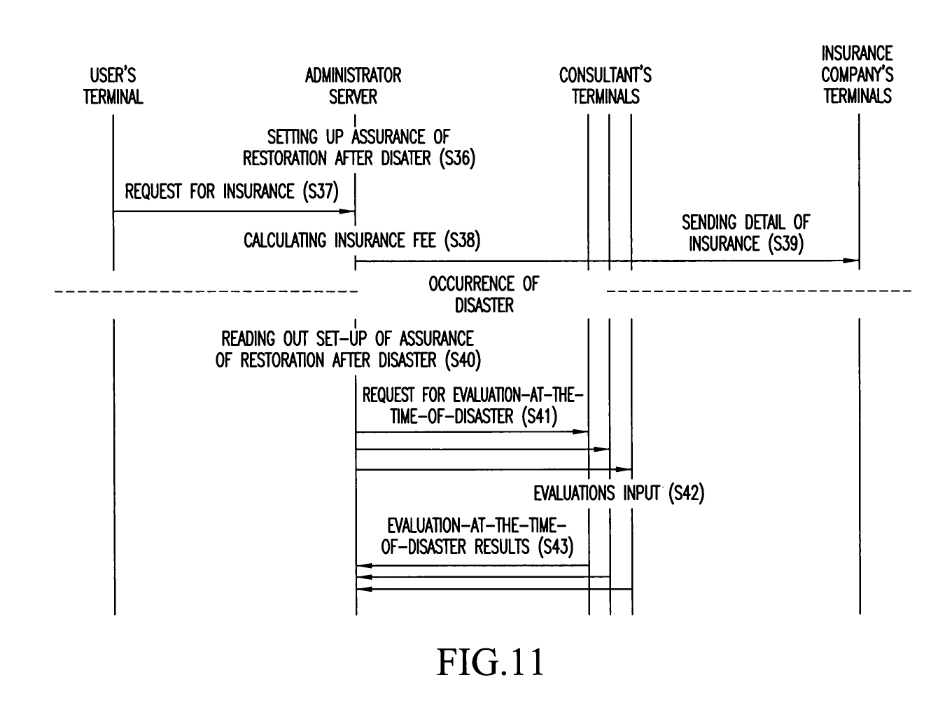

At step S36 in FIG. 11, the administrator server 100 sets up the assurance of restoration after a disaster based on the evaluation list (including the re-evaluation list), which is obtained by integrating the evaluation results made by each of the specialized consultants regarding the earthquake resistance of each of the various components of a target building.

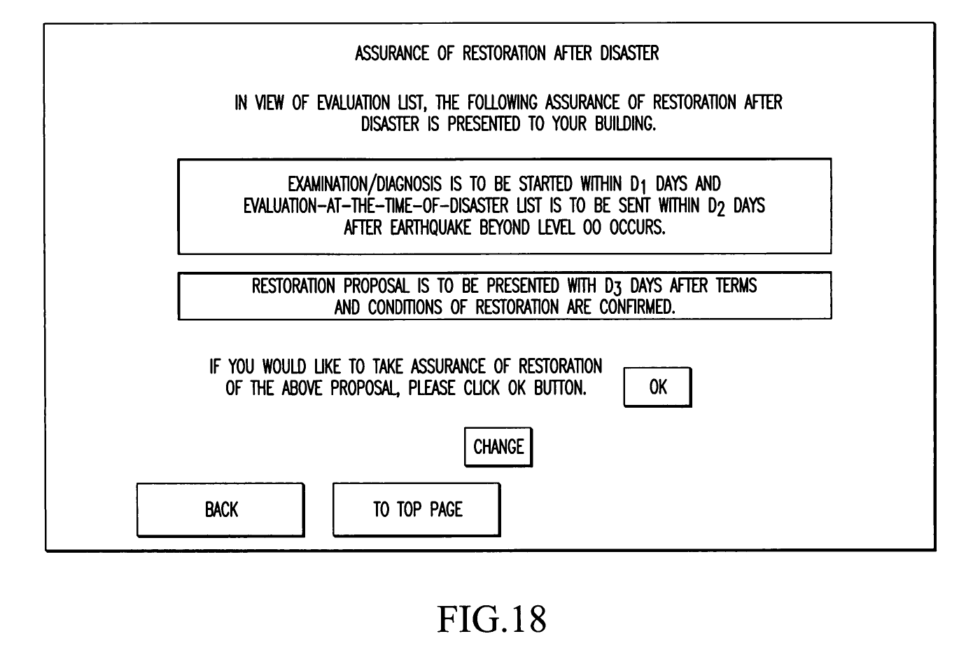

More precisely, the administrator server 100 sets up a draft proposal for the assurance of restoration after a disaster. The server 100 then sends a set-up draft proposal to the building owner's terminal 200a, 200b so that the proposal can be displayed on the building owner's terminal 200a, 200b. FIG. 18 illustrates the displayed image of the draft proposal of the assurance of restoration after a disaster.

In the example of FIG. 18, the following are set up, i.e., the time period from the day of an earthquake disaster beyond a predetermined level of earthquake disaster to the day of starting an examination and diagnosis, the time period until sending the evaluation list of the building at the time of sustaining the earthquake disaster (evaluation-at-the-time-of-disaster list) and the time period until presenting the restoration proposal after confirming the terms and conditions of the restoration which the building owner requests. The details of the draft proposal of the assurance of restoration after a disaster should preferably be set up based on the evaluation list (or the re-evaluation list). That is, since the relationship between a level of an earthquake disaster and a degree of the damage of a building depends on a degree of earthquake resistance of each component of the building, the details of the assurance of restoration to be determined in advance also depends on a degree of earthquake resistance of each component of the building. More precisely, the predetermined level of an earthquake disaster, which determines whether to begin an examination and diagnosis depends on a degree of the earthquake resistance of each of the buildings.

If the evaluation list states that each of the components has a restorability for a level I earthquake, but it is found that there was no actual restorability after having sustained an earthquake of level I, a special assurance can be included in the assurance of restoration after a disaster. Thus, a high reliability of the evaluation list can be sustained by setting up the details of the assurance of restoration after a disaster based on the evaluation list.

When the OK button is clicked on the displayed image of the draft proposal of the assurance of restoration after a disaster shown in FIG. 18, the administrator server 100 finally sets up the assurance of restoration after a disaster. Technically, the set-up of the assurance of restoration after a disaster is stored in the administrator server 100 as a booking order and the server 100 reads out the set-up details of the assurance of restoration after a disaster when an earthquake disaster actually occurs.

Earthquake Insurance

The evaluation list and the rating, which are fair and accurate are obtained by integrating the evaluations of each of the specialized consultants. Accordingly, an insurance fee for earthquake insurance can be set in detail based on the fair and accurate evaluation list and rating.

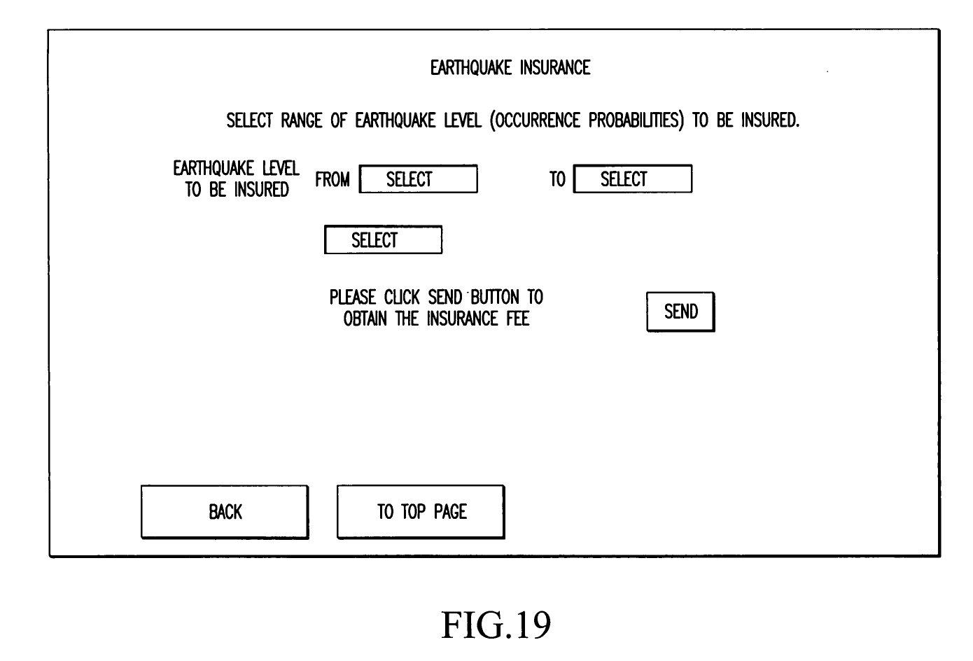

At step S37 in FIG. 11, the administrator server 100 receives a request for earthquake insurance from the building owner's terminal 200a, 200b. To be more precise, an earthquake insurance setting form shown in FIG. 19 is displayed by clicking the earthquake insurance button on the top page shown in FIG. 14 or the evaluation result page shown in FIG. 16. The level range of the earthquake (corresponding to after-mentioned Annualized Occurrence probabilities) and the period insured by the earthquake insurance are selected and the send button is clicked to request earthquake insurance for the building. Earthquake insurance is obtained in order to have money paid if an earthquake disaster occurs.

At step S38, the administrator server 100 sets up the insurance fee of the earthquake insurance based on the evaluation list (including the re-evaluation list), which is obtained by integrating the evaluation results made by each of the specialized consultants regarding the earthquake resistance of each of the components of a target building.

An Annualized Loss Exceeding Curve, which is suitable for an evaluation result pattern is specified by referring to an Annualized Loss Exceeding Curve list shown in FIG. 28, which determines the relationship between the evaluation result pattern and the Annualized Loss Exceeding Curve. The evaluation result pattern represents an evaluation result for safety, restorability and serviceability with respect to each of the components of a building (building frame, finish, equipment, fixtures and grounds) in the evaluation list.

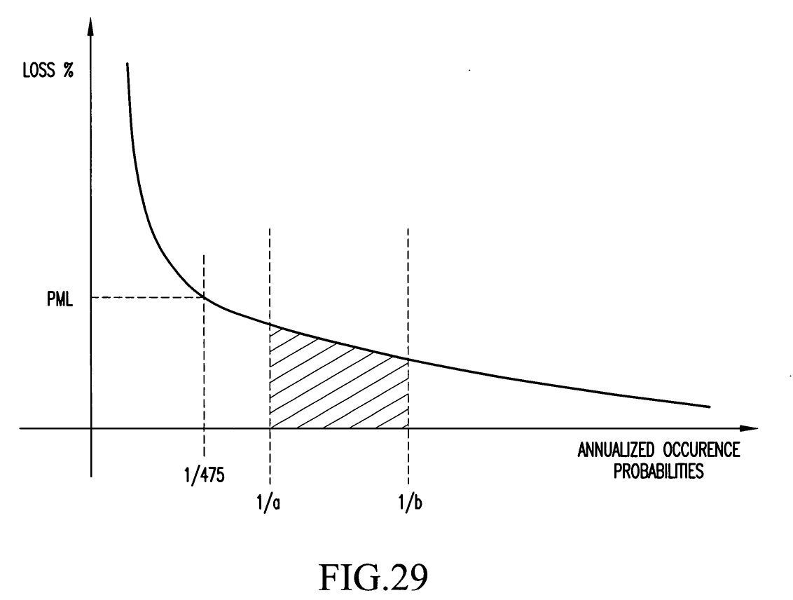

An example of an Annualized Loss Exceeding Curve is shown in FIG. 29. The horizontal axis represents the Annualized Occurrence Probabilities. For example, 1/10 is the Annualized Occurrence Probabilities in the case of an earthquake level, which typically occurs once every 10 years. The vertical axis represents an expected loss (%) caused by an earthquake of a corresponding level. For example, in the case of an earthquake of a level, which occurs once every 475 years, the Annualized Occurrence Probabilities is 1/475 and the loss corresponding to a probability of 1/475 is the aforementioned PML (Probable Maximum Loss).

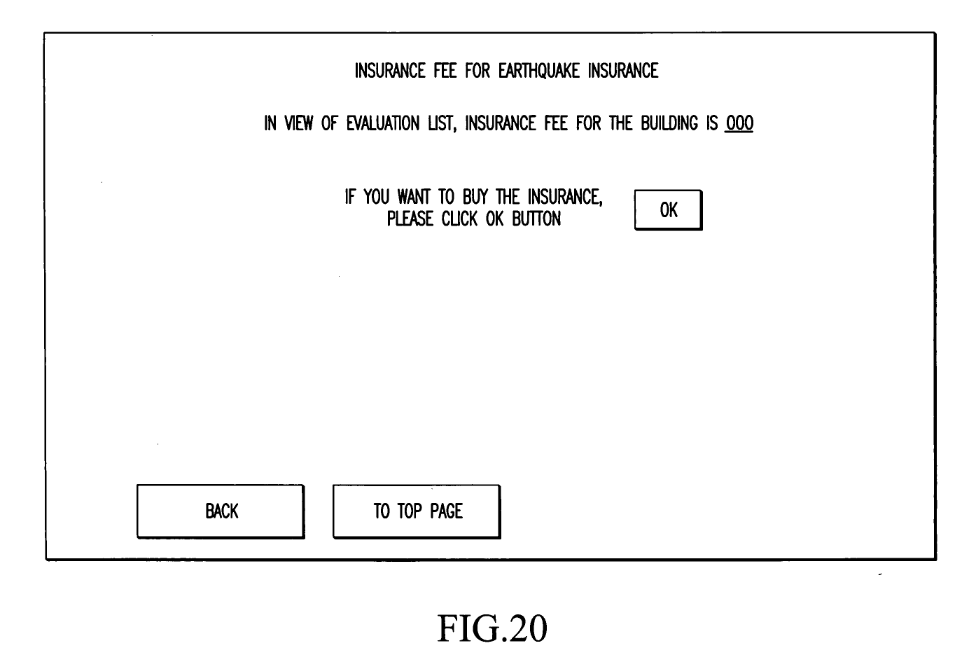

If the level range of an earthquake insured by earthquake insurance selected at step S37 is from a once-per-(b)-year level to a once-per-(a)-year level, a hatching area portion in the graph of FIG. 29 is the area insured by the earthquake insurance. The insurance fee is calculated based on the area. Thus an insurance fee can be calculated by having an accurate Annualized Loss Exceedance Curve according to the evaluation result pattern in a detailed evaluation list. The administrator server 100 sends the calculated insurance fee to a building owner's terminal 200a, 200b for display as shown in FIG. 20.

At step S39, the administrator server 100 sends a detail of insurance to the insurance companies' terminals 500a-500c when the OK button for buying insurance is clicked on the displayed image shown in FIG. 20. The insurance company can also calculate the insurance fee. The insurance company can also set up the insurance fee based on the above-mentioned evaluation list (or re-evaluation list) prepared by integrating the evaluation of the earthquake resistance made by each of the specialized consultants, which leads to a more reasonable setting of the insurance fee.

Processing at the Time of Earthquake Disaster

The processing at the time when an earthquake occurs and after an earthquake occurs will now be explained below. At step S40 in FIG. 11, the set-up detail of the assurance of restoration after a disaster is stored as a booking order and is read out upon being informed of the occurrence of an earthquake by a building owner, for example.

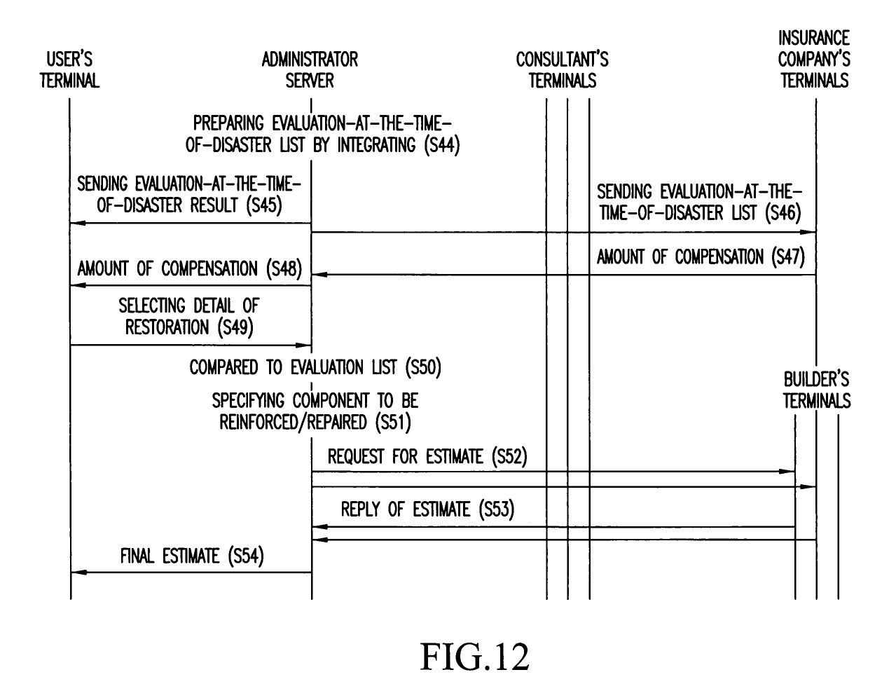

At step S41, a request for an evaluation-at-the-time-of-disaster is sent to each of the specialized consultants' terminals 300a-300c. At step S42, the evaluations are input at each of the specialized consultants' terminals 300a-300c. At step S43, the administrator server 100 then receives an evaluation-at-the-time-of-disaster results from the terminals 300a-300c. At step S44 in FIG. 12, an evaluation-at-the-time-of-disaster list is prepared by integrating the evaluation-results-at-the-time of-disaster. This processing is performed in the same way as the aforementioned processing for preparing the evaluation list.

At step S45, the administrator server 100 sends an evaluation result at the time of disaster regarding the entire building to the building owner's terminal 200a, 200b. The administrator server, preferably, also sends the evaluation-at-the-time-of-disaster to the insurance companies' terminals 500a-500c at step S46. The evaluation-at-the-time-of-disaster list can be used by the insurance company for determining an amount of compensation.

At step S47, the administrator server 100 receives data regarding the amount of compensation from the insurance companies' terminals 500a-500c and sends the data regarding the amount of compensation to the building owner's terminal 200a, 200b at step S48.

At step S49, the administrator server 100 receives the request for selecting a detail of restoration from the building owner's terminal 200a, 200b. At step S50, a model evaluation list corresponding to the request is prepared for comparison to the evaluation-at-the-time-of-disaster list actually prepared at the step S44. As a result, items (components) to be reinforced and/or broken components to be repaired are specified at step S51. At step S52, a request for estimation is sent to each of the builders' terminals 400a-400c. At step S53, the administrator server 100 receives a reply of an estimate from the builders' terminals 400a-400c. At step S54, an overhead for the administrator to supervise the actual work is added to the replied estimate. The administrator server 100 sends a final estimate with the added overhead to the building owner's terminal 200a, 200b. The final estimate includes not only the necessary cost, but also a specification of the work. In other words, this final estimate is also a restoration proposal.

Upon receiving approval of the estimate at step S55, the administrator server 100 sends an instruction to start the work to each of the builders' terminals 400a-400c. As a result, each builder starts the restoration work. In the normal situation after all of the restoration work is completed, a set of services regarding rating, reinforcement work, assurance of restoration after disaster, earthquake insurance etc. is presented from step S1.

The method and apparatus for managing the risk of a disaster has been described above using an earthquake as an example. However the method and apparatus for managing risk can be applied to risk management for other kinds of disasters as well.

For example, in the case of managing the risk of a disaster by wind and/or snow with respect to a building, an evaluation list for the risk of disaster on the entire building can be prepared by the steps of classifying components of a target building into a plurality of segments; sending a request for an evaluation on the risk of a disaster with respect to each of the components to a plurality of specialized consultants prepared according to the segments together with a building ID; receiving the evaluation results regarding the risk of a disaster with respect to each of the components from each of specialized consultants' terminals; and integrating the evaluation results.

In the aforementioned processing, processing at step S7 corresponds to a stage for receiving building data of a target building, processing at step S8 corresponds to a stage for issuing identifying information in order to connect the building data with the target building. Processing at step S9 corresponds to a stage for classifying the various components of a building into a plurality of segments based on the building data. Step S10 corresponds to a stage for sending a request for an evaluation, with a building ID, regarding the risk of a disaster with respect to each of the components to the terminals of a plurality of specialized consultants who are prepared according to segments into which the components of a building are classified. Processing at step S12 corresponds to a stage for receiving the evaluation results regarding the risk of a disaster with respect to each of the components from each of the specialized consultants' terminals together with the building ID. Step S13 corresponds to a stage for preparing an evaluation regarding the risk of a disaster of the entire building (evaluation list) by integrating the plurality of evaluation results having the same identifying information.

Steps S14 and S16 correspond to a stage for making a rating of the building with respect to the risk of a disaster based on the evaluation list and sending the rating result to the building owner's terminal 200a, 200b. Step S17 corresponds to a stage for receiving a request for changing the rating to a requested rating when the building owner requests a higher rating. Step S18 corresponds to a stage for comparing the evaluation list of the entire building with a model evaluation list, which corresponds to the requested rating., Step S19 corresponds to a stage for specifying a component of the building to be reinforced based on the comparison result. Step S22 corresponds to a stage for sending the evaluation list, model evaluation list, building data and request for estimate for reinforcement work to the terminal of a builder linked to the specified component.

Step S36 corresponds to a stage for setting up an assurance of restoration after a disaster based on the evaluation list. Step S38 corresponds to a stage for calculating an insurance fee for disaster insurance, from which insurance money is paid when a disaster occurs, based on the evaluation list.

The method for managing risk of a disaster is performed in the same manner as the above-described method for managing the risk of an earthquake.

An evaluation list of the entire building is prepared by integrating a plurality of the evaluation results having the same identifying information after receiving the identifying-information-attached evaluation results regarding the risk of a disaster with respect to each of the components of a building from each of the specialized consultant's terminals. Accordingly, it is possible to make a specialized consultant who is highly capable of designing and constructing a building to participate in evaluating the risk of a disaster on a building and to obtain a fair and accurate evaluation of the entire building by integrating the evaluation results regarding the risk of a disaster on the building made by a plurality of specialized consultants.

The rating of a building is made based on an evaluation list prepared by integrating the evaluation results regarding the risk of a disaster on the building made by a plurality of specialized consultants. Therefore, it is possible to make a rating through the opinions of a plurality of specialized consultants. Particularly, if a reputable, reliable and highly capable administrator runs the CERA website, a highly reliable rating can be obtained. This leads to a highly reliable evaluation of the value of real estate.

A proposal for reinforcement work is presented based on an evaluation list prepared by integrating the evaluation results regarding the risk of a disaster on the building made by a plurality of specialized consultants. Accordingly, a proper amount of reinforcement work, i.e., not too much and not too little reinforcement work, can be presented. Also a specialized builder can perform sure and reliable reinforcement work based on a particular proposal.

Reliable re-rating can also be presented after the reinforcement work is performed. As a result, an increase in the value of the real estate can be confirmed.

By referring to an evaluation list prepared by integrating the evaluation results regarding the risk of a disaster on the building made by a plurality of specialized consultants, the details of risk assurance can be clearly and quantitatively set up between the building owner and the administrator with respect to the following subsequent series of services of assurance of restoration after disaster, calculation of insurance fee, proposal of reinforcement work and carrying out restoration work.

A comprehensive service including an evaluation regarding the risk of a disaster, rating, disaster insurance and assurance of restoration after a disaster can be bought through a single contract. Consequently, a building owner can avoid the necessity of contracting with many different individuals of companies. In addition, the building owner can receive a series of services by contacting only a single individual or company (server administrator), which leads to a saving of trouble and quick service. As a result, smooth services without misunderstanding and trouble can be received with respect to the series of services of an evaluation regarding the risk of a disaster, rating, disaster insurance, assurance of restoration after disaster, etc.

An assurance of restoration at the time of an actual disaster is set up based on the evaluation list. Accordingly, the building owner can obtain in advance a certain assurance of quick restoration.

Disaster insurance such as earthquake insurance for a building can be presented based on a level of risk assurance which is set up based on an evaluation list prepared by integrating the evaluation results regarding the risk of a disaster on the building made by a plurality of specialized consultants.

An effective assurance of restoration after a disaster can be set up based on an evaluation list prepared by integrating the evaluation results regarding the risk of a disaster on the building made by a plurality of specialized consultants.

Even after a disaster occurs, an accurate and fair evaluation-at-the-time-of-disaster can be presented by integrating the evaluation results on the damage of the building made by a plurality of specialized consultants.

A certain amount of insurance compensation can be presented based on the accurate and fair evaluation-at-the-time-of-disaster.

The way in which the restoration work is performed can be presented based on the accurate and fair evaluation-at-the-time-of-disaster. Also a specialized builder can carry out the restoration work with certainty and reliability.

A comprehensive series of services can be presented when a disaster occurs and after a disaster occurs.

The method and apparatus for managing the risk of a disaster of the present invention is not limited to the above description. A variety of modifications can be made within the scope of the invention.

For example, in the above description, the case is disclosed where the administrator makes a final judgment with respect to the services presented and owes a direct responsibility to the building owner. In that case, the administrator is presenting his/her own output after he/she judges in a comprehensive way by integrating the output from all of the different agents (specialized consultant, builder and insurance company). As for building work, the administrator not only hires the builder but also supervises the actual work. Therefore, the administrator in the case is not only capable of coordinating as a mere broker but also is capable of making practical services based on a high level engineering ability. However another person, for example, a trading company can also be an administrator where the administrator functions as a mere broker for coordination. In this case, it is also possible to make a specialized consultant who is highly capable of designing and constructing a building participate in evaluating the risk of a disaster on a building.

It is possible to make a fair and accurate evaluation of the entire building to obtain a reliable rating by integrating the evaluation results regarding the risk of a disaster on the building made by a plurality of specialized consultants. Accordingly, comprehensive services including an evaluation regarding the risk of a disaster, rating, disaster insurance and assurance of restoration after a disaster can be presented.

It should also be noted that the present invention can be provided as a computer-readable article of manufacture having embodied thereon software comprising a plurality of code segments that implement the method of the present invention in order to manage the risk of a disaster on a building. The computer-readable article of manufacture could be, for example, a disk, a CD ROM, a tape, a propagated signal, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for managing the risk of a disaster on a building utilizing an administrator server, said method comprising steps of:
issuing identifying information to identify the building;
classifying components of the building into a plurality of segments;
sending a request for evaluation with the identifying information regarding the risk of a disaster with respect to each of the components of the building to a plurality of specialized consultants corresponding to each of the plurality of segments;
receiving evaluation results with the identifying information regarding the risk of a disaster with respect to each of the components from each of the plurality of specialized consultants; and
preparing an evaluation regarding the risk of a disaster on the entire building by integrating the plurality of evaluation results having the same identifying information.

2. The method according to claim 1, further comprising the steps of:
rating the building with respect to the risk of a disaster based on the evaluation regarding the risk of a disaster on the entire building; and
sending a rating result to a building owner.

3. The method according to claim 2, further comprising the steps of:
receiving a request for changing the rating result to a requested rating when the building owner requests a higher rating;
specifying a component of the building to be reinforced; and
sending a request for an estimate of the reinforcement work to a builder corresponding to the specified component.

4. The method according to claim 1, further comprising a step of setting up an assurance of restoration after a disaster based on the evaluation regarding the risk of a disaster on the entire building.

5. The method according to claim 1, further comprising the step of calculating an insurance fee for disaster insurance from which insurance money is paid when a disaster occurs based on the evaluation regarding the risk of a disaster on the entire building.

6. The method according to claim 1, wherein the disaster is an earthquake.

7. The method according to claim 1, further comprising the steps of:
sending a request for evaluation at the time of a disaster to the plurality of specialized consultants;
receiving a plurality of evaluation at the time of a disaster results from each of the plurality of specialized consultants; and
preparing an evaluation at the time of a disaster on the entire building by integrating the evaluation results at the time of a disaster received from the plurality of specialized consultants.

8. The method according to claim 7, further comprising the steps of:
sending the evaluation at the time of a disaster to at least one building owner and at least one insurance company;
receiving data regarding an amount of compensation for damage from a disaster from said at least one insurance company; and
sending the data regarding an amount of compensation to the at least one building owner.

9. The method according to claim 8, further comprising the steps of:
sending a request for an estimate to a plurality of builders corresponding to each of the plurality of specialized consultants;
receiving an estimate from each of the plurality of builders; and
sending a final estimate to each of the at least one building owner.

10. A computer-readable article of manufacture having embodied thereon software comprising a plurality of code segments that implement the method of claim 1 in order to manage the risk of a disaster on a building.

11. An apparatus for managing the risk of a disaster on a building utilizing an administrator server, said apparatus comprising:
means for issuing identifying information to identify the building;
means for classifying components of the building into a plurality of segments;
means for sending a request for evaluation with the identifying information regarding the risk of a disaster with respect to each of the components of the building to a plurality of specialized consultants corresponding to each of the plurality of segments;
means for receiving evaluation results with the identifying information regarding the risk of a disaster with respect to each of the components from each of the plurality of specialized consultants; and
means for preparing an evaluation regarding the risk of a disaster on the entire building by integrating the plurality of evaluation results having the same identifying information.

12. The apparatus according to claim 11, further comprising:
means for rating the building with respect to the risk of a disaster based on the evaluation regarding the risk of a disaster on the entire building; and
means for sending the rating result to a building owner.

13. The apparatus according to claim 12, further comprising:
means for receiving a request for changing the rating to a requested rating when the building owner requests a higher rating;
means for specifying a component of the building to be reinforced; and
means for sending a request for an estimate of the reinforcement work to a builder corresponding to the specified component.

14. The apparatus according to claim 11, further comprising means for setting up an assurance of restoration after a disaster based on the evaluation regarding the risk of a disaster on the entire building.

15. The apparatus according to claim 11, further comprising means for calculating an insurance fee for disaster insurance from which insurance money is paid when a disaster occurs based on the evaluation regarding the risk of a disaster on the entire building.

16. The apparatus according to claim 1 1, wherein the disaster is an earthquake.

17. The apparatus according to claim 11, further comprising the steps of:
means for sending a request for evaluation at the time of a disaster to the plurality of specialized consultants;
means receiving a plurality of evaluation results at the time of a disaster from each of the plurality of specialized consultants; and
means for preparing an evaluation at the time of a disaster on the entire building by integrating the evaluation at the time of a disaster results received from the plurality of specialized consultants.

18. The apparatus according to claim 17, further comprising the steps of:
means for sending the evaluation at the time of a disaster to at least one building owner and at least one insurance company;
means for receiving data regarding an amount of compensation for damage from a disaster from said at least one insurance company; and
means for sending the data regarding an amount of compensation to the at least one building owner.

19. The apparatus according to claim 18, further comprising the steps of:
means for sending a request for an estimate to a plurality of builders corresponding to each of the plurality of specialized consultants;
means for receiving an estimate from each of the plurality of builders; and
means for sending a final estimate to each of the at least one building owner.
